(19) United States
(12) Patent Application Publication
(10) Pub. No.: US 2024/0043633 A1
(43) Pub. Date: Feb. 8, 2024

(54) POLYPROPYLENE POLYMER FOR PRODUCING BIAXIALLY ORIENTED FILMS AND OTHER ARTICLES

(71) Applicant: W.R. Grace & Co.-CONN., Columbia, MD (US)

(72) Inventor: Jan W. Van Egmond, Columbia, MD (US)

(73) Assignee: W.R. Grace & Co.-CONN., Columbia, MD (US)

(21) Appl. No.: 18/039,704

(22) PCT Filed: Nov. 30, 2021
(86) PCT No.: PCT/US2021/061246

§ 371 Date: May 31, 2023

Related U.S. Application Data
(60) Provisional application No. 63/122,134, filed on Dec. 7, 2020.

(51) Int. Cl. C08J 5/18; C08F 110/06

(52) U.S. Cl. CPC C08J 5/18; C08F 110/06; C08J 2323/12

(57) ABSTRACT

Olefin polymers are produced having a controlled amount of xylene soluble content. For example, polypropylene polymers can be produced having a relatively high xylene soluble content. The polymers are produced using particular external electron donors. The polymers can be produced without using a silicon-containing external electron donor. The process has been found to produce not only polymers with relatively high xylene soluble content but with less fines and a narrow particle size distribution

### CROSS-REFERENCE TO RELATED APPLICATIONS

This application claims the benefit of priority to U.S. Provisional Application No. 63/122,134, filed on Dec. 7, 2020, the entirety of which is incorporated herein by reference.

### BACKGROUND

Polyolefin polymers are used in numerous and diverse applications and fields. Polyolefin polymers, for instance, are thermoplastic polymers that can be easily processed. The polyolefin polymers can also be recycled and reused. Polyolefin polymers are formed from hydrocarbons, such as ethylene, propylene, and other alpha-olefins, which are obtained from petrochemicals and are abundantly available.

Polypropylene polymers, which are one type of polyolefin polymer, generally have a linear structure based on a propylene monomer. Polypropylene polymers can have various different stereospecific configurations. Polypropylene polymers, for example, can be isotactic, syndiotactic, and atactic. Isotactic polypropylene is perhaps the most common form and can be highly crystalline. Polypropylene polymers that can be produced include homopolymers, modified polypropylene polymers, and polypropylene copolymers, which include polypropylene terpolymers. By modifying the polypropylene or copolymerizing the propylene with other monomers, various different polymers can be produced having desired properties for a particular application.

In one application, polypropylene polymers are produced and formulated for producing films. One type of film formed from polypropylene polymers, for instance, are biaxially oriented films. Biaxially oriented films are produced through an extrusion or casting process in which the polypropylene polymer is reduced to a molten state formed into a film and then stretched in both the machine direction and the cross machine direction. These films have high value and can be used in numerous applications. For example, in one application, the film can be incorporated into packaging film, including food packaging film. Packaging film can be made from multiple polymer film layers in which a biaxially stretched polypropylene film can comprise one or more of the layers. Packaging films can have various requirements related to transparency, thickness, and strength. When producing food packaging film, for instance, the film also should have an oxygen transmission rate within controlled limits. Oxygen transmission through the film, for instance, prevents stimulated bacteria growth inside the package and thus increases the shelf life of the product.

When forming biaxially oriented polypropylene films, the polymer is required to have various physical properties in order for the film to be formed without damage or without an unacceptable level of imperfections. For instance, the polypropylene polymer should be capable of being extruded into a very thin film thickness and should be capable of being stretched in multiple directions without breaking.

In this regard, those skilled in the art have been attempting to continuously improve the properties of polypropylene polymers in order to form very thin extruded and cast articles, including oriented films. The present disclosure is directed to further improvements in producing polypropylene polymers and to polypropylene polymers made from the process that are well suited for use in producing films and other applications.

### SUMMARY

The present disclosure is generally directed to a process for producing polyolefin polymers, such as polypropylene polymers, that are well suited to producing films, fibers and other molded articles. The present disclosure is also directed to a polypropylene composition made from the process and to films produced from the polymer. In accordance with the present disclosure, polypropylene polymers are produced having a controlled amount of xylene soluble content that provides processing advantages when later used to form articles and products. The process of the present disclosure has also been found to unexpectedly produce polymer particles having a more uniform size distribution and containing very low fines.

In one aspect, the present disclosure is directed to a polymer composition comprising a polypropylene polymer. The polypropylene polymer can be a polypropylene homopolymer or a polypropylene copolymer containing one or more comonomers in an amount less than about 1% by weight. In accordance with the present disclosure, the polypropylene polymer is produced having a xylene soluble content of greater than 4% by weight, such as greater than about 5% by weight, such as greater than about 5.5% by weight, such as greater than about 6% by weight, such as greater than about 6.2% by weight, such as greater than about 6.4% by weight, and generally less than about 8.5% by weight. The polypropylene polymer has a melt flow rate of from about 0.5 g/10 min to about 20 g/10 min, such as from about 1 g/10 min to about 5 g/10 min. The polypropylene polymer can be formed in the presence of a Ziegler-Natta catalyst that does not contain a silicon-based external electron donor. Thus, the polypropylene polymer of the present disclosure can contain silicon in an amount less than about 30 ppm, such as less than about 10 ppm, such as less than about 5 ppm. In one aspect, the polypropylene polymer is free of silicon.

Polypropylene polymers made according to the present disclosure have a very beneficial particle size distribution that allows for easy handling and processing. For example, when the polypropylene polymer particles of the present disclosure are tested according to a Sieve Test, the polypropylene particles can have a particle size distribution such that greater than about 65% by weight of the particles, such as greater than about 70% by weight of the particles, such as greater than about 75% by weight of the particles, such as greater than about 80% by weight of the particles fall between a 1000 micron Sieve and a 500 micron Sieve. Less than 1% by weight of the particles, such as less than about 0.75% by weight of the particles, such as less than about 0.5% by weight of the particles fall through a 75 micron Sieve indicating very low fines. In one aspect, greater than about 20% by weight of the particles, such as greater than about 15% by weight of the particles fall between a 500 micron Sieve and a 225 micron Sieve.

The polypropylene polymer can generally have a molecular weight distribution of greater than about 2.5, such as greater than about 3, such as greater than about 3.5, and generally less than about 7, such as less than about 6.

The present disclosure is also directed to a polymer film made from the polymer composition described above. The polymer film can comprise a biaxially oriented polymer film layer. The polymer film layer can have a thickness of less than about 50 microns, such as less than about 30 microns, such as less than about 10 microns.

The polymer film can be a single layer or monolayer film made from the biaxially oriented polymer layer containing the polypropylene composition. Alternatively, the biaxially oriented polymer layer of the present disclosure can comprise one or more layers of a multilayer film. The polymer film can be a packaging film, such as food packaging film.

The present disclosure is also directed to a process for producing olefin polymers. The process includes polymerizing a propylene monomer in the presence of a of a Ziegler-Natta catalyst. The catalyst can include a solid catalyst component and an activity-limiting agent. The solid catalyst component can comprise a magnesium moiety, a titanium moiety, and an internal electron donor. In accordance with the present disclosure, the propylene monomer is polymerized in the presence of the catalyst and in the absence of any external electron donor containing silicon. For example, in one aspect, the propylene monomer can be polymerized in the presence of the activity-limiting agent and not in the presence of any other external electron donors. In this manner, the xylene soluble content of the resulting polymer can be controlled and increased for producing polymers well suited for use in making biaxially oriented films.

The internal electron donor contained in the Ziegler-Natta catalyst can be a substituted phenylene diester. The activity-limiting agent, on the other hand, can be a carboxylic acid ester, a diether, a poly(alkene glycol), a poly(alkene glycol)ester, a diol ester, and combinations thereof. The carboxylic acid ester can be an aliphatic or aromatic, mono- or poly-carboxylic acid ester including inertly substituted derivatives thereof. In one aspect, the molar ratio of co-catalyst (e.g. triethylaluminum (TEAL)) to the activity-limiting agent can be less than about 5, such as less than about 4.5, and generally greater than about 2.5.

Other features and aspects of the present disclosure are discussed in greater detail below.

### BRIEF DESCRIPTION OF THE DRAWING

A full and enabling disclosure of the present invention, including the best mode thereof to one skilled in the art, is set forth more particularly in the remainder of the specification, which includes reference to the accompanying FIGURE.

The FIGURE is a graphical representation of some of the results obtained in the examples described herein.

### DEFINITIONS AND TESTING PROCEDURES

Melt flow rate (MFR), as used herein, is measured in accordance with the ASTM D1238 test method at 230° C. with a 2.16 kg weight for propylene-based polymers. The melt flow rate can be measured in pellet form or on the reactor powder. When measuring the reactor powder, a stabilizing package can be added including 2000 ppm of CYANOX 2246 antioxidant (methylenebis(4-methyl-6-tert-butylphenol) 2000 ppm of IRGAFOS 168 antioxidant (tris(2,4-di-tert.-butylphenyl)phosphite) and 1000 ppm of add scavenger ZnO.

For high melt flow rate polymers, the testing die orifice may be smaller as indicated here: Equipment includes Tungsten carbide large orifice 2.0955±0.0051 mm (0.0825±0.0002″) I.D.×8.000±0.025 mm (0.315±0.001″) long; and Tungsten carbide small orifice 1.0490±0.0051 mm (0.0413±0.0002″) I.D.×4.000±0.025 mm (0.1575±long. Position the piston and die in the cylinder and seat firmly on the base plate. Maintain the temperature for at least 15 minutes before beginning a test. When equipment is used repetitiously, it should not be necessary to heat the piston and die for 15 min. For Polypropylene materials having a melt index greater than 50, the small orifice is used.

Calculations for polypropylene polymers:

| Step | Action |
|---|---|
| 1 | 1/4 inch timing interval with large die, |
| | $Melt Flow = \frac{200}{TestTime}$ |
| 2 | One inch timing interval with large die, |
| | $Melt flow = \frac{800}{TestTime}$ |
| 3 | 1/4 inch timing interval with small die, |
| | $Melt Flow = \frac{1600}{TestTime}$ |
| 4 | One inch timing interval with small die, |
| | $Melt flow = \frac{6400}{TestTime}$ |

Particle size can be measured using a sieve test. The sieve test is conducted on a GRADEX Particle Size Analyzer commercially available from Rotex Global. Average particle size based on weight fractions is determined from the particle size distribution obtained from the GRADEX Particle Size Analyzer. Fines are defined as the weight fraction of polymer particles that pass through the GRADEX 120 mesh (125 microns).

Xylene solubles (XS) is defined as the weight percent of resin that remains in solution after a sample of polypropylene random copolymer resin is dissolved in hot xylene and the solution is allowed to cool to 25° C. This is also referred to as the gravimetric XS method according to ASTM D5492-06 using a 60-minute precipitation time and is also referred to herein as the “wet method”.

The ASTM D5492-06 method mentioned above may be adapted to determine the xylene soluble portion. In general, the procedure consists of weighing 2 g of sample and dissolving the sample in 200 ml o-xylene in a 400 ml flask with 24/40 joint. The flask is connected to a water-cooled condenser and the contents are stirred and heated to reflux under nitrogen (N2), and then maintained at reflux for an additional 30 minutes. The solution is then cooled in a temperature controlled water bath at 25° C. for 60 minutes to allow the crystallization of the xylene insoluble fraction. Once the solution is cooled and the insoluble fraction precipitates from the solution, the separation of the xylene soluble portion (XS) from the xylene insoluble portion (XI) is achieved by filtering through 25-micron filter paper. One hundred ml of the filtrate is collected into a pre-weighed aluminum pan, and the o-xylene is evaporated from this 100 ml of filtrate under a nitrogen stream. Once the solvent is evaporated, the pan and contents are placed in a 100° C. vacuum oven for 30 minutes or until dry. The pan is then allowed to cool to room temperature and weighed. The xylene soluble portion is calculated as XS (wt %)=[(m3−m2)*2/m1]*100, where m1 is the original weight of the sample used, m2 is the weight of empty aluminum pan, and m3 is the weight of the pan and residue (the asterisk, *, here and elsewhere in the disclosure indicates that the identified terms or values are multiplied).

XS can also be measured according to the Viscotek method, as follows: 0.4 g of polymer is dissolved in 20 ml of xylenes with stirring at 130° C. for 60 minutes. The solution is then cooled to 25° C. and after 60 minutes the insoluble polymer fraction is filtered off. The resulting filtrate is analyzed by Flow Injection Polymer Analysis using a Viscotek ViscoGEL H-100-3078 column with THF mobile phase flowing at 1.0 ml/min. The column is coupled to a Viscotek Model 302 Triple Detector Array, with light scattering, viscometer and refractometer detectors operating at 45° C. Instrument calibration is maintained with Viscotek PolyCAL™ polystyrene standards. A polypropylene (PP) homopolymer, such as biaxially oriented polypropylene (BOPP) grade Dow 5D98, is used as a reference material to ensure that the Viscotek instrument and sample preparation procedures provide consistent results. The value for the reference polypropylene homopolymer, such as 5D98, is initially derived from testing using the ASTM method identified above.

The weight average molecular weight (Mw), the number average molecular weight (Mn), the molecular weight distribution (Mw/Mn) (also referred to as “MWD”) and higher average molecular weights (Mz/Mw) are measured by GPC according to the Gel Permeation Chromatography (GPC) Analytical Method for Polypropylene. The polymers are analyzed on Polymer Char High Temperature GPC with IRS MCT (Mercury Cadmium Telluride-high sensitivity, thermoelectrically cooled IR detector), Polymer Char four capillary viscometer, a Wyatt 8 angle MALLS and three Agilent Plgel Olexis (13 um). The oven temperature is set at 150° C. The solvent is nitrogen purged 1,2,4-trichlorobenzene (TCB) containing ˜200 ppm 2,6-di-t-butyl-4-methylphenol (BHT). The flow rate is 1.0 mL/min and the injection volume was 200 μl. A 2 mg/mL sample concentration is prepared by dissolving the sample in N2 purged and preheated TCB (containing 200 ppm BHT) for 2 hours at 160° C. with gentle agitation.

The GPC column set is calibrated by running twenty narrow molecular weight distribution polystyrene standards. The molecular weight (MW) of the standards ranges from 266 to 12,000,000 g/mol, and the standards were contained in 6 “cocktail” mixtures. Each standard mixture has at least a decade of separation between individual molecular weights. The polystyrene standards are prepared at 0.005 g in 20 mL of solvent for molecular weights equal to or greater than 1,000,000 g/mol and 0.001 g in 20 mL of solvent for molecular weights less than 1,000,000 g/mol. The polystyrene standards are dissolved at 160° C. for 60 min under stirring. The narrow standards mixtures are run first and in order of decreasing highest molecular weight component to minimize degradation effect. A logarithmic molecular weight calibration is generated using a fourth-order polynomial fit as a function of elution volume. The equivalent polypropylene molecular weights are calculated by using following equation with reported Mark-Houwink coefficients for polypropylene (Th. G. Scholte, N. L. J. Meijerink, H. M. Schoffeleers, and A. M. G. Brands, J. Appl. Polym. Sci., 29, 3763-3782 (1984)) and polystyrene (E. P. Otocka, R. J. Roe, N. Y. Hellman, P. M. Muglia, Macromolecules, 4, 507 (1971)):

$$\text{?}$$

$$\text{?} \text{indicates text missing or illegible when filed}$$

Where Mpp is PP equivalent MW, MPS is PS equivalent MW, log K and a values of Mark-Houwink coefficients for PP and PS are listed below.

TABLE 2

| Polymer | A | Log K |
|---|---|---|
| Polypropylene | 0.725 | −3.721 |
| Polystyrene | 0.702 | −3.900 |

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As utilized herein with respect to numerical ranges, the terms “approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, the present disclosure is directed to a process for producing polyolefin polymers, namely polypropylene polymers that have a controlled amount of xylene solubles. The present disclosure is also directed to polymer compositions containing the polypropylene polymer and to articles made from the polypropylene polymer composition. Polypropylene polymers made according to the present disclosure generally have a relatively high xylene soluble content, which makes them well suited to producing films and fibers. For example, in one aspect, the polypropylene polymer of the present disclosure can be used to produce biaxially oriented films. The films can be used in all different types of applications, such as a packaging film. The film can be used alone or in combination with other polymer layers.

The amount of xylene solubles contained in the polymer is controlled in accordance with the present disclosure through the use of a particular catalyst system. More particularly, non-silicon containing external electron donors are used to produce the polypropylene polymers. In the past, for instance, silicon containing external electron donors were used to control xylene soluble amounts. Unexpectedly, however, it was discovered that not only can xylene soluble levels be controlled without the use of a silicon-containing external electron donor, but various other advantages and benefits can be obtained.

In one aspect, for instance, the polypropylene polymers made according to the present disclosure are formed in the presence of a Ziegler-Natta catalyst. The Ziegler-Natta catalyst includes a base catalyst component in combination with an internal electron donor. The internal electron donor, for instance, can be a substituted phenyl diester. During polymerization, the base catalyst component as described above is combined with a cocatalyst and one or more external electron donors. In accordance with the present disclosure, the external electron donors can be one or more activity-limiting agents that not only act as an external electron donor but also reduce catalyst activity at elevated temperatures. The one or more activity-limiting agents present during polymerization can be carboxylic acid esters. The one or more activity-limiting agents are used to produce the polypropylene polymers in the absence of any other external electron donors, particularly silicon-containing external electron donors.

Through the process of the present disclosure, for instance, polypropylene polymers can be produced that have a xylene soluble content of greater than about 4%, such as greater than about 4.5%, such as greater than about 5%, such as greater than about 5.5%, such as greater than about 6%, and generally less than about 8%, such as less than about 7% while containing little to no silicon. For example, polypropylene polymers made according to the present disclosure can contain silicon in an amount less than about 30 ppm, such as in an amount less than about 20 ppm, such as in an amount less than about 10 ppm, such as in an amount less than about 5 ppm, such as in an amount less than about 3 ppm, such as in an amount less than about 2 ppm. In one aspect, polypropylene polymers made according to the present disclosure can be free of silicon.

In addition to controlling the xylene soluble content, the catalyst system and process of the present disclosure can also produce polypropylene polymers with little to no fines and with a relatively uniform particle size distribution. It was discovered, for instance, that less particle break up occurs during polymerization of the polymer leading to extremely low levels of fines. This result was unexpected and surprising. In fact, polypropylene polymers made according to the present disclosure can contain fines (e.g. polymer particles that fall through a 125 micron sieve) of less than about 2% by weight, such as less than about 1.5% by weight, such as less than about 1% by weight, such as less than about 0.75% by weight, such as less than about 0.5% by weight.

In addition to producing extremely small amounts of fines, polymers produced according to the present disclosure have a relatively uniform particle size distribution. For instance, greater than 65% by weight of the polymer particles can fall between a 1,000-micron sieve and a 500-micron sieve. More particularly, greater than 70% by weight of the polymer particles, such as greater than about 75% by weight of the polymer particles, such as greater than about 80% by weight of the polymer particles fall between a 1000-micron sieve and a 500-micron sieve. In addition, less than about 20% by weight, such as less than about 15% by weight of the particles fall between a 500-micron sieve and a 225-micron sieve. The average particle size can generally be greater than about 0.55 mm, such as greater than about mm, such as greater than about 0.625 mm and generally less than about 0.8 mm, such as less than about 0.7 mm.

In addition to using one or more activity-limiting agents as the external electron donor without the use of any silicon-containing external electron donors, the polymerization process can be operated such that the cocatalyst to external electron donor ratio be less than about 8, such as less than about 7.5, and particularly less than 6, such as less than about 5.8, such as less than about 5.6, such as less than about 5.4 and generally greater than about 2, such as greater than about 3, such as greater than about 3.5. Having greater amounts of external electron donor or one or more activity-limiting agents in comparison to cocatalyst produces a process with good operability characteristics. For example, the higher electron donor concentration in relation to cocatalyst helps with improved reactor continuity, which may be a factor in leading to lower fines and less particle breakup.

The process of the present disclosure can be used to produce various different types of polypropylene polymers. In one aspect, the process of the present disclosure is used to produce polypropylene homopolymers. Alternatively, polypropylene copolymers, such as polypropylene random copolymers, can be produced. In one embodiment, a random copolymer polypropylene can be manufactured that contains less than about 1% by weight comonomer, such as less than about 0.5% by weight comonomer. The comonomer can be any suitable alkylene, such as ethylene.

Polypropylene polymers made according to the present disclosure have a relatively high xylene soluble content in conjunction with a melt flow rate generally less than about 20 g/10 min. The melt flow rate of the polymer, for instance, can be less than about 15 g/10 min, such as less than about 10 g/10 min, such as less than about 8 g/10 min, such as less than about 6 g/10 min, such as less than about 4 g/10 min, and generally greater than about 0.5 g/10 min, such as greater than about 1 g/10 min, such as greater than about 2 g/10 min.

The molecular weight distribution of the polymer is generally greater than 2.5 in that the polymer is formed from a Ziegler Natta catalyst. For instance, the molecular weight distribution can be greater than about 3, such as greater than about 3.5, such as greater than about 4, such as greater than about 4.5, and generally less than about 8, such as less than about 7, such as less than about 6.

Polypropylene polymers having the above characteristics are well suited to forming films, such as biaxially oriented films. Polymers made according to the present disclosure having a relatively high xylene soluble content, for instant, can be used to form relatively thin films. The films, for instance, can have a thickness of from about 1 micron to about 50 microns, including all intervals of 1 micron therebetween. For example, the film can have a thickness of less than about 40 microns, such as less than about 30 microns, such as less than about 20 microns, such as less than about 15 microns, such as less than about 10 microns. The film thickness is generally greater than about 2 microns, such as greater than about 4 microns, such as greater than about 6 microns, such as greater than about 8 microns.

Biaxially oriented films made in accordance with the present disclosure can be used in a monolayer product or in a multilayer product. When used in a multilayer product, the film of the present disclosure can be combined with various other film layers.

The film forming process may include one or more of the following procedures: extrusion, coextrusion, cast extrusion, blown film formation, double bubble film formation, tenter frame techniques, calendaring, coating, dip coating, spray coating, lamination, biaxial orientation, injection molding, thermoforming, compression molding, and any combination of the foregoing.

In an embodiment, the process includes forming a multilayer film. The term “multilayer film” is a film having two or more layers. Layers of a multilayer film are bonded together by one or more of the following nonlimiting processes: coextrusion, extrusion coating, vapor deposition coating, solvent coating, emulsion coating, or suspension coating.

In an embodiment, the process includes forming an extruded film. The term “extrusion,” and like terms, is a process for forming continuous shapes by forcing a molten plastic material through a die, optionally followed by cooling or chemical hardening. Immediately prior to extrusion through the die, the relatively high-viscosity polymeric material is fed into a rotating screw, which forces it through the die. The extruder can be a single screw extruder, a multiple screw extruder, a disk extruder, or a ram extruder. The die can be a film die, blown film die, sheet die, pipe die, tubing die or profile extrusion die. Nonlimiting examples of extruded articles include pipe, film, and/or fibers.

In an embodiment, the process includes forming a coextruded film. The term “coextrusion,” and like terms, is a process for extruding two or more materials through a single die with two or more orifices arranged so that the extrudates merge or otherwise weld together into a laminar structure. At least one of the coextruded layers contains the present propylene-based polymer. Coextrusion may be employed as an aspect of other processes, for instance, in film blowing, casting film, and extrusion coating processes.

In an embodiment, the process includes forming a blown film. The term “blown film,” and like terms, is a film made by a process in which a polymer or copolymer is extruded to form a bubble filled with air or another gas in order to stretch the polymeric film. Then, the bubble is collapsed and collected in flat film form.

The catalyst system and process that may be used to form polymers in accordance with the present disclosure will now be described. The polypropylene polymer of the present disclosure is produced in the presence of a Ziegler-Natta catalyst. The catalyst includes a solid catalyst component combined with an internal electron donor. The internal electron donor can be a substituted phenylene diester. During polymerization, the solid catalyst component is combined with a cocatalyst and an external electron donor. The cocatalyst is generally an aluminum compound. In accordance with the present disclosure, the external electron donors incorporated into the catalyst system can be activity-limiting agents that can, for instance, include carboxylic acid esters such as isopropyl myristate, pentyl valerate, or mixtures thereof. Better control over xylene soluble content and lower fines can be achieved when forming the polymer in the absence of any silicon-containing external electron donors, such as any silanes. In addition, during the process, the cocatalyst to external electron donor molar ratio can be maintained below 6, such as below 5, such as below 4.5, such as below 4, such as below 3.5, and generally greater than 1, such as greater than 2. Thus, the ratio of external electron donor to cocatalyst is relatively high which is believed to help improve reactor continuity.

The solid catalyst component can include (i) magnesium, (ii) a transition metal compound of an element from Periodic Table groups IV to VIII, (iii) a halide, an oxyhalide, and/or an alkoxide of (i) and/or (ii), and (iv) combinations of (i), (ii), and (iii). Nonlimiting examples of suitable catalyst components include halides, oxyhalides, and alkoxides of magnesium, manganese, titanium, vanadium, chromium, molybdenum, zirconium, hafnium, and combinations thereof.

In one embodiment, the preparation of the catalyst component involves halogenation of mixed magnesium and titanium alkoxides.

In various embodiments, the catalyst component is a magnesium moiety compound (MagMo), a mixed magnesium titanium compound (MagTi), or a benzoate-containing magnesium chloride compound (BenMag). In one embodiment, the catalyst precursor is a magnesium moiety (“MagMo”) precursor. The MagMo precursor includes a magnesium moiety. Nonlimiting examples of suitable magnesium moieties include anhydrous magnesium chloride and/or its alcohol adduct, magnesium alkoxide or aryloxide, mixed magnesium alkoxy halide, and/or carboxylated magnesium dialkoxide or aryloxide. In one embodiment, the MagMo precursor is a magnesium di(C₁₋₄)alkoxide. In a further embodiment, the MagMo precursor is diethoxymagnesium.

In another embodiment, the catalyst component is a mixed magnesium/titanium compound (“MagTi”). The “MagTi precursor” has the formula Mg_{d}Ti(OR^{e})fX_{g} wherein R^{e} is an aliphatic or aromatic hydrocarbon radical having 1 to 14 carbon atoms or COR′ wherein R′ is an aliphatic or aromatic hydrocarbon radical having 1 to 14 carbon atoms; each OR^{e} group is the same or different; X is independently chlorine, bromine or iodine, preferably chlorine; d is 0.5 to 56, or 2 to 4; f is 2 to 116 or 5 to 15; and g is 0.5 to 116, or 1 to 3. The precursors are prepared by controlled precipitation through removal of an alcohol from the reaction mixture used in their preparation. In an embodiment, a reaction medium comprises a mixture of an aromatic liquid, especially a chlorinated aromatic compound, most especially chlorobenzene, with an alkanol, especially ethanol. Suitable halogenating agents include titanium tetrabromide, titanium tetrachloride or titanium trichloride, especially titanium tetrachloride. Removal of the alkanol from the solution used in the halogenation, results in precipitation of the solid precursor, having especially desirable morphology and surface area. Moreover, the resulting precursors are particularly uniform in particle size.

In another embodiment, the catalyst precursor is a benzoate-containing magnesium chloride material (“BenMag”). As used herein, a “benzoate-containing magnesium chloride” (“BenMag”) can be a catalyst (i.e., a halogenated catalyst component) containing a benzoate internal electron donor. The BenMag material may also include a titanium moiety, such as a titanium halide. The benzoate internal donor is labile and can be replaced by other electron donors during catalyst and/or catalyst synthesis. Nonlimiting examples of suitable benzoate groups include ethyl benzoate, methyl benzoate, ethyl p-methoxybenzoate, methyl p-ethoxybenzoate, ethyl p-ethoxybenzoate, ethyl p-chlorobenzoate. In one embodiment, the benzoate group is ethyl benzoate. In an embodiment, the BenMag catalyst component may be a product of halogenation of any catalyst component (i.e., a MagMo precursor or a MagTi precursor) in the presence of a benzoate compound.

In another embodiment, the solid catalyst component can be formed from a magnesium moiety, a titanium moiety, an epoxy compound, optionally an organosilicon compound, and an internal electron donor. In one embodiment, an organic phosphorus compound can also be incorporated into the solid catalyst component. For example, in one embodiment, a halide-containing magnesium compound can be dissolved in a mixture that includes an epoxy compound, an organic phosphorus compound, and a hydrocarbon solvent.

The resulting solution can be treated with a titanium compound in the presence of an organosilicon compound and optionally with an internal electron donor to form a solid precipitate. The solid precipitate can then be treated with further amounts of a titanium compound. The titanium compound used to form the catalyst can have the following chemical formula:

Ti(OR)_{g}X_{4-g}

where each R is independently a C₁-C₄ alkyl; X is Br, Cl, or I; and g is 0, 1, 2, 3, or 4.

In some embodiments, the organosilicon is a monomeric or polymeric compound. The organosilicon compound may contain —Si—O—Si— groups inside of one molecule or between others. Other illustrative examples of an organosilicon compound include polydialkylsiloxane and/or tetraalkoxysilane. Such compounds may be used individually or as a combination thereof. The organosilicon compound may be used in combination with aluminum alkoxides and an internal electron donor.

The aluminum alkoxide referred to above may be of formula Al(OR′)₃ where each R′ is individually a hydrocarbon with up to 20 carbon atoms. This may include where each R′ is individually methyl, ethyl, n-propyl, iso-propyl, n-butyl, sec-butyl, tert-butyl, n-pentyl, iso-pentyl, neo-pentyl, etc.

Examples of the halide-containing magnesium compounds include magnesium chloride, magnesium bromide, magnesium iodide, and magnesium fluoride. In one embodiment, the halide-containing magnesium compound is magnesium chloride.

Illustrative of the epoxy compounds include, but are not limited to, glycidyl-containing compounds of the Formula:

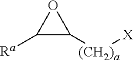

wherein “a” is from 1, 2, 3, 4, or 5, X is F, Cl, Br, I, or methyl, and R^{a} is H, alkyl, aryl, or cyclyl. In one embodiment, the alkylepoxide is epichlorohydrin. In some embodiments, the epoxy compound is a haloalkylepoxide or a nonhaloalkylepoxide.

According to some embodiments, the epoxy compound can be ethylene oxide; propylene oxide; 1,2-epoxybutane; 2,3-epoxybutane; 1,2-epoxyhexane; 1,2-epoxyoctane; 1,2-epoxydecane; 1,2-epoxydodecane; 1,2-epoxytetradecane; 1,2-epoxyhexadecane; 1,2-epoxyoctadecane; 7,8-epoxy-2-methyloctadecane; 2-vinyl oxirane; 2-methyl-2-vinyl oxirane; 1,2-epoxy-5-hexene; 1,2-epoxy-7-octene; 1-phenyl-2,3-epoxypropane; 1-(1-naphthyl)-2,3-epoxypropane; 1-cyclohexyl-3,4-epoxybutane; 1,3-butadiene dioxide; 1,2,7,8-diepoxyoctane; cyclopentene oxide; cyclooctene oxide; α-pinene oxide; 2,3-epoxynorbornane; limonene oxide; cyclodecane epoxide; 2,3,5,6-diepoxynorbornane; styrene oxide; 3-methyl styrene oxide; 1,2-epoxybutylbenzene; 1,2-epoxyoctylbenzene; stilbene oxide; 3-vinylstyrene oxide; 1-(1-methyl-1,2-epoxyethyl)-3-(1-methylvinyl benzene); 1,4-bis(1,2-epoxypropyl)benzene; 1,3-bis(1,2-epoxy-1-methylethyl)benzene; 1,4-bis(1,2-epoxy-1-methylethyl)benzene; epifluorohydrin; epichlorohydrin; epibromohydrin; hexafluoropropylene oxide; 1,2-epoxy-4-fluorobutane; 1-(2,3-epoxypropyl)-4-fluorobenzene; 1-(3,4-epoxybutyl)-2-fluorobenzene; 1-(2,3-epoxypropyl)-4-chlorobenzene; 1-(3,4-epoxybutyl)-3-chlorobenzene; 4-fluoro-1,2-cyclohexene oxide; 6-chloro-2,3-epoxybicyclo[2.2.1]heptane; 4-fluorostyrene oxide; 1-(1,2-epoxypropyl)-3-trifluorobenzene; 3-acetyl-1,2-epoxypropane; 4-benzoyl-1,2-epoxybutane; 4-(4-benzoyl)phenyl-1,2-epoxybutane; 4,4′-bis(3,4-epoxybutyl)benzophenone; 3,4-epoxy-1-cyclohexanone; 2,3-epoxy-5-oxobicyclo[2.2.1]heptane; 3-acetylstyrene oxide; 4-(1,2-epoxypropyl)benzophenone; glycidyl methyl ether; butyl glycidyl ether; 2-ethylhexyl glycidyl ether; allyl glycidyl ether; ethyl 3,4-epoxybutyl ether; glycidyl phenyl ether; glycidyl 4-tert-butylphenyl ether; glycidyl 4-chlorophenyl ether; glycidyl 4-methoxyphenyl ether; glycidyl 2-phenylphenyl ether; glycidyl 1-naphthyl ether; glycidyl 2-phenylphenyl ether; glycidyl 1-naphthyl ether; glycidyl 4-indolyl ether; glycidyl N-methyl-α-quinolon-4-yl ether; ethyleneglycol diglycidyl ether; 1,4-butanediol diglycidyl ether; 1,2-diglycidyloxybenzene; 2,2-bis(4-glycidyloxyphenyl)propane; tris(4-glycidyloxyphenyl)methane; poly(oxypropylene)triol triglycidyl ether; a glycidic ether of phenol novolac; 1,2-epoxy-4-methoxycyclohexane; 2,3-epoxy-5,6-dimethoxybicyclo[2.2.1]heptane; 4-methoxystyrene oxide; 1-(1,2-epoxybutyl)-2-phenoxybenzene; glycidyl formate; glycidyl acetate; 2,3-epoxybutyl acetate; glycidyl butyrate; glycidyl benzoate; diglycidyl terephthalate; poly(glycidyl acrylate); poly(glycidyl methacrylate); a copolymer of glycidyl acrylate with another monomer; a copolymer of glycidyl methacrylate with another monomer; 1,2-epoxy-4-methoxycarbonylcyclohexane; 2,3-epoxy-5-butoxycarbonylbicyclo[2.2.1]heptane; ethyl 4-(1,2-epoxyethyl)benzoate; methyl 3-(1,2-epoxybutyl)benzoate; methyl 3-(1,2-epoxybutyl)-5-pheylbenzoate; N,N-glycidyl-methylacetamide; N,N-ethylglycidylpropionamide; N,N-glycidylmethylbenzamide; N-(4,5-epoxypentyl)-N-methyl-benzamide; N,N-diglycylaniline; bis(4-diglycidylaminophenyl)methane; poly(N,N-glycidylmethylacrylamide); 1,2-epoxy-3-(diphenylcarbamoyl)cyclohexane; 2,3-epoxy-6-(dimethylcarbamoyl)bicycle[2.2.1]heptane; 2-(dimethylcarbamoyl)styrene oxide; 4-(1,2-epoxybutyl)-4′-(dimethylcarbamoyl)biphenyl; 4-cyano-1,2-epoxybutane; 1-(3-cyanophenyl)-2,3-epoxybutane; 2-cyanostyrene oxide; or 6-cyano-1-(1,2-epoxy-2-phenylethyl)naphthalene.

As an example of the organic phosphorus compound, phosphate acid esters such as trialkyl phosphate acid ester may be used. Such compounds may be represented by the formula:

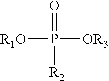

wherein R₁, R₂, and R₃ are each independently selected from the group consisting of methyl, ethyl, and linear or branched (C₃-C₁₀) alkyl groups. In one embodiment, the trialkyl phosphate acid ester is tributyl phosphate acid ester.

In still another embodiment, substantially spherical magnesium chloride particles can be formed and used as the base catalyst component. The spherical particles can be formed from a magnesium chloride and alcohol adduct, such as a MgCl₂-nEtOH adduct, formed through a spray crystallization process. In the process, a MgCl₂-nROH melt, where n is 1-6, can be sprayed inside a vessel while conducting inert gas at a temperature of 20-80° C. into the upper part of the vessel. The melt droplets are transferred to a crystallization area into which inert gas is introduced at a temperature of −50 to 20° C. crystallizing the melt droplets into nonagglomerated, solid particles of spherical shape. The spherical MgCl₂ particles are then classified into the desired size. Particles of undesired size can be recycled. In one aspect, the spherical MgCl₂ precursor can have an average particle size (Malvern d₅₀) of between about 15-150 microns, preferably between 20-100 microns, and most preferably between 35-85 microns.

The catalyst component may be converted to a solid catalyst by way of halogenation. Halogenation includes contacting the catalyst component with a halogenating agent in the presence of the internal electron donor. Halogenation converts the magnesium moiety present in the catalyst component into a magnesium halide support upon which the titanium moiety (such as a titanium halide) is deposited. Not wishing to be bound by any particular theory, it is believed that during halogenation the internal electron donor (1) regulates the position of titanium on the magnesium-based support, (2) facilitates conversion of the magnesium and titanium moieties into respective halides and (3) regulates the crystallite size of the magnesium halide support during conversion. Thus, provision of the internal electron donor yields a catalyst composition with enhanced stereoselectivity.

In an embodiment, the halogenating agent is a titanium halide having the formula Ti(OR^{e})_{f}Xₕ wherein R^{e} and X are defined as above, f is an integer from 0 to 3; h is an integer from 1 to 4; and f+h is 4. In an embodiment, the halogenating agent is TiCl₄. In a further embodiment, the halogenation is conducted in the presence of a chlorinated or a non-chlorinated aromatic liquid, such as dichlorobenzene, o-chlorotoluene, chlorobenzene, benzene, toluene, or xylene. In yet another embodiment, the halogenation is conducted by use of a mixture of halogenating agent and chlorinated aromatic liquid comprising from 40 to 60 volume percent halogenating agent, such as TiCl₄.

The reaction mixture can be heated during halogenation. The catalyst component and halogenating agent are contacted initially at a temperature of less than about 10° C., such as less than about 0° C., such as less than about −10° C., such as less than about −20° C., such as less than about −30° C. The initial temperature is generally greater than about −50° C., such as greater than about −40° C. The mixture is then heated at a rate of 0.1 to 10.0° C./minute, or at a rate of 1.0 to 5.0° C./minute. The internal electron donor may be added later, after an initial contact period between the halogenating agent and catalyst component. Temperatures for the halogenation are from 20° C. to 150° C. (or any value or subrange therebetween), or from 0° C. to 120° C.

The manner in which the catalyst component, the halogenating agent and the internal electron donor are contacted may be varied. In an embodiment, the catalyst component is first contacted with a mixture containing the halogenating agent and a chlorinated aromatic compound. The resulting mixture is stirred and may be heated if desired. Next, the internal electron donor is added to the same reaction mixture without isolating or recovering of the precursor. The foregoing process may be conducted in a single reactor with addition of the various ingredients controlled by automated process controls.

In one embodiment, the catalyst component is contacted with the internal electron donor before reacting with the halogenating agent.

Contact times of the catalyst component with the internal electron donor are at least 10 minutes, or at least 15 minutes, or at least 20 minutes, or at least 1 hour at a temperature from at least −30° C., or at least −20° C., or at least 10° C. up to a temperature of 150° C., or up to 120° C., or up to 115° C., or up to 110° C.

In one embodiment, the catalyst component, the internal electron donor, and the halogenating agent are added simultaneously or substantially simultaneously.

The halogenation procedure may be repeated one, two, three, or more times as desired. In an embodiment, the resulting solid material is recovered from the reaction mixture and contacted one or more times in the absence (or in the presence) of the same (or different) internal electron donor components with a mixture of the halogenating agent in the chlorinated aromatic compound for at least about 10 minutes, or at least about 15 minutes, or at least about 20 minutes, and up to about 10 hours, or up to about 45 minutes, or up to about minutes, at a temperature from at least about −20° C., or at least about 0° C., or at least about 10° C., to a temperature up to about 150° C., or up to about 120° C., or up to about 115° C.

After the foregoing halogenation procedure, the resulting solid catalyst composition is separated from the reaction medium employed in the final process, by filtering for example, to produce a moist filter cake. The moist filter cake may then be rinsed or washed with a liquid diluent to remove unreacted TiCl₄ and may be dried to remove residual liquid, if desired. Typically, the resultant solid catalyst composition is washed one or more times with a “wash liquid,” which is a liquid hydrocarbon such as an aliphatic hydrocarbon such as isopentane, isooctane, isohexane, hexane, pentane, or octane. The solid catalyst composition then can be separated and dried or slurried in a hydrocarbon, especially a relatively heavy hydrocarbon such as mineral oil for further storage or use.

In one embodiment, the resulting solid catalyst composition has a titanium content of from about 1.0 percent by weight to about 6.0 percent by weight, based on the total solids weight, or from about 1.5 percent by weight to about 4.5 percent by weight, or from about 2.0 percent by weight to about 3.5 percent by weight. The weight ratio of titanium to magnesium in the solid catalyst composition is suitably between about 1:3 and about 1:160, or between about 1:4 and about 1:50, or between about 1:6 and 1:30. In an embodiment, the internal electron donor may be present in the catalyst composition in a molar ratio of internal electron donor to magnesium of from about 0.005:1 to about 1:1, or from about 0.01:1 to about 0.4:1. Weight percent is based on the total weight of the catalyst composition.

The catalyst composition may be further treated by one or more of the following procedures prior to or after isolation of the solid catalyst composition. The solid catalyst composition may be contacted (halogenated) with a further quantity of titanium halide compound, if desired; it may be exchanged under metathesis conditions with an acid chloride, such as phthaloyl dichloride or benzoyl chloride; and it may be rinsed or washed, heat treated; or aged. The foregoing additional procedures may be combined in any order or employed separately, or not at all.

As described above, the catalyst composition can include a combination of a magnesium moiety, a titanium moiety, and the internal electron donor. The catalyst composition is produced by way of the foregoing halogenation procedure that converts the catalyst component and the internal electron donor into the combination of the magnesium and titanium moieties, into which the internal electron donor is incorporated. The catalyst component from which the catalyst composition is formed can be any of the above described catalyst precursors, including the magnesium moiety precursor, the mixed magnesium/titanium precursor, the benzoate-containing magnesium chloride precursor, the magnesium, titanium, epoxy, and phosphorus precursor, or the spherical precursor.

Various different types of internal electron donors may be incorporated into the solid catalyst component. In one embodiment, the internal electron donor is an aryl diester, such as a phenylene-substituted diester. In one embodiment, the internal electron donor may have the following chemical structure:

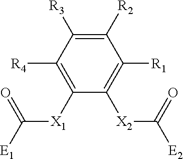

wherein R₁ R₂, R₃ and R₄ are each a hydrocarbyl group having from 1 to 20 carbon atoms, the hydrocarbyl group having a branched or linear structure or comprising a cycloalkyl group having from 5 to 15 carbon atoms, and where E₁ and E₂ are the same or different and selected from the group consisting of an alkyl having 1 to 20 carbon atoms, a substituted alkyl having 1 to 20 carbon atoms, an aryl having 1 to 20 carbon atoms, a substituted aryl having 1 to 20 carbon atoms, or an inert functional group having 1 to 20 carbon atoms and optionally containing heteroatoms, and wherein X₁ and X₂ are each O, S, an alkyl group, or NR₅ and wherein R₅ is a hydrocarbyl group having 1 to 20 carbon atoms or is hydrogen.

As used herein, the term “hydrocarbyl” and “hydrocarbon” refer to substituents containing only hydrogen and carbon atoms, including branched or unbranched, saturated or unsaturated, cyclic, polycyclic, fused, or acyclic species, and combinations thereof. Nonlimiting examples of hydrocarbyl groups include alkyl-, cycloalkyl-, alkenyl-, alkadienyl-, cycloalkenyl-, cycloalkadienyl-, aryl-, aralkyl, alkylaryl, and alkynyl-groups.

As used herein, the terms “substituted hydrocarbyl” and “substituted hydrocarbon” refer to a hydrocarbyl group that is substituted with one or more nonhydrocarbyl substituent groups. A nonlimiting example of a nonhydrocarbyl substituent group is a heteroatom. As used herein, a “heteroatom” refers to an atom other than carbon or hydrogen. The heteroatom can be a non-carbon atom from Groups IV, V, VI, and VII of the Periodic Table. Nonlimiting examples of heteroatoms include: halogens (F, Cl, Br, I), N, O, P, B, and S. As used herein, the term “halohydrocarbyl” group refers to a hydrocarbyl group that is substituted with one or more halogen atoms.

In one aspect, the substituted phenylene diester has the following structure (I):

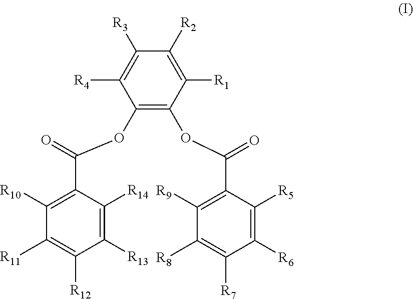

In an embodiment, structure (I) includes R₁ and R₃ that is an isopropyl group. Each of R₂, R₄ and R₅-R₁₄ is hydrogen.

In an embodiment, structure (I) includes each of R₁, R₅, and R₁₀ as a methyl group and R₃ is a t-butyl group. Each of R₂, R₄, R₆-R₉, and R₁₁-R₁₄ is hydrogen.

In an embodiment, structure (I) includes each of R₁, R₅, and R₁₀ as a methyl group and R₃ is a t-butyl group. Each of R₂, R₄, R₆-R₉, and R₁₁-R₁₄ is hydrogen.

In an embodiment, structure (I) includes each of R₁ and R₄ as a methyl group and R₃ is a cycloalkyl group containing from 3 to 8 carbon atoms, such as a cyclohexyl group or a cyclopentyl group. Each of R₂, R₅, R₆, R₇, R₈, R₉, R₁₀, R₁₁, R₁₂, R₁₃, and R₁₄ can be hydrogen.

In an embodiment, structure (I) includes R₁ as a methyl group and R₃ is a t-butyl group. Each of R₇ and Rig is an ethyl group. Each of R₂, R₄, R₅, R₆, R₈, R₉, R₁₀, R₁₁, R₁₃, and R₁₄ is hydrogen.

In an embodiment, structure (I) includes each of R₁, R₅, R₇, R₉, R₁₀, R₁₂, and R₁₄ as a methyl group and R₃ is a t-butyl group. Each of R₂, R₄, R₆, R₈, R₁₁, and R₁₃ is hydrogen.

In an embodiment, structure (I) includes R₁ as a methyl group and R₃ is a t-butyl group. Each of R₅, R₇, R₉, R₁₀, R₁₂, and R₁₄ is an i-propyl group. Each of R₂, R₄, R₆, R₈, R₁₁, and RH is hydrogen.

In an embodiment, the substituted phenylene aromatic diester has a structure selected from the group consisting of structures (II)-(V), including alternatives for each of R₁ to R₁₄, that are described in detail in U.S. Pat. No. 8,536,372, which is incorporated herein by reference.

In an embodiment, structure (I) includes R₁ that is a methyl group and R₃ is a t-butyl group. Each of R₇ and R₁₂ is an ethoxy group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is an flourine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is an chlorine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is an bromine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is an iodine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₆, R₇, R₁₁, and R₁₂ is a chlorine atom. Each of R₂, R₄, R₅, R₈, R₉, R₁₀, R₁₃, and R₁₄ is hydrogen.

In an embodiment, structure (I) includes R₁ that is a methyl group and R₃ is a t-butyl group. Each of R₆, R₈, R₁₁, and R₁₃ is a chlorine atom. Each of R₂, R₄, R₅, R₉, R₁₀, R₁₂ and R₁₄ is hydrogen.

In an embodiment, structure (I) includes R₁ that is a methyl group and R₃ is a t-butyl group. Each of R₂, R₄, and R₅-R₁₄ is a fluorine atom.

In an embodiment, structure (I) includes R₁ that is a methyl group and R₃ is a t-butyl group. Each of R₇ and R₁₂ is a trifluoromethyl group. Each of R₂, R₄, R₅, R₆, R₈, R₉, R₁₀, R₁₁, R₁₃, and R₁₄ is hydrogen.

In an embodiment, structure (0.1) includes R₁ that is a methyl group and R₃ is a t-butyl group. Each of R₇ and R₁₂ is an ethoxycarbonyl group. Each of R₂, R₄, R₅, R₆, R₈, R₉, R₁₀, R₁₁, R₁₃, and R₁₄ is hydrogen.

In an embodiment, R₁ is methyl group and R₃ is a t-butyl group. Each of R₇ and R₁₂ is an ethoxy group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a diethylamino group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a 2,4,4-trimethylpentan-2-yl group. Each of R₂, R₄, and R₅-R₁₄ is hydrogen.

In an embodiment, structure (I) includes R₁ and R₃, each of which is a sec-butyl group. Each of R₂, R₄, and R₅-R₁₄ is hydrogen.

In an embodiment, structure (I) includes R₁ and R₄ that are each a methyl group. Each of R₂, R₃, R₅-R₉, and R₁₀-R₁₄ is hydrogen.

In an embodiment, structure (I) includes R₁ that is a methyl group. R₄ is an i-propyl group. Each of R₂, R₃, R₅-R₉ and R₁₀-R₁₄ is hydrogen.

In an embodiment, structure (I) includes R₁, R₃, and R₄, each of which is an i-propyl group. Each of R₂, R₅-R₉, and R₁₀-R₁₄ is hydrogen.

In another aspect, the internal electron donor can be a phthalate compound. For example, the phthalate compound can be dimethyl phthalate, diethyl phthalate, dipropyl phthalate, diisopropyl phthalate, dibutyl phthalate, diisobutyl phthalate, diamyl phthalate, diisoamyl phthalate, methylbutyl phthalate, ethylbutyl phthalate, or ethylpropyl phthalate.

The solid catalyst component and the internal electron donor can be combined with one or more external electron donors. As used herein, an “external electron donor” is a component or a composition comprising a mixture of components added independent of the other catalyst components that modifies the catalyst performance. In one aspect, the one or more external electron donors added during polymerization are one or more activity-limiting agents. As used herein, an “activity-limiting agent” is a composition that decreases catalyst activity as the polymerization temperature in the presence of the catalyst rises above a threshold temperature (e.g., temperature greater than about 85° C.).

The activity-limiting agent may be a carboxylic acid ester. The aliphatic carboxylic acid ester may be a C₄-C₃₀ aliphatic acid ester, may be a mono- or a poly- (two or more) ester, may be straight chain or branched, may be saturated or unsaturated, and any combination thereof. The C₄-C₃₀ aliphatic acid ester may also be substituted with one or more Group 14, 15, or 16 heteroatom containing substituents. Nonlimiting examples of suitable C_{4-C30} aliphatic acid esters include C₁₋₂₀ alkyl esters of aliphatic C₄₋₃₀ monocarboxylic acids, C₁₋₂₀ alkyl esters of aliphatic C₈₋₂₀ monocarboxylic acids, C₁₋₄ allyl mono- and diesters of aliphatic C₄₋₂₀ monocarboxylic acids and dicarboxylic acids, C₁₋₄ alkyl esters of aliphatic C₈₋₂₀ monocarboxylic acids and dicarboxylic acids, and C₄₋₂₀ mono- or polycarboxylate derivatives of C₂₋₁₀₀ (poly)glycols or C₂₋₁₀₀ (poly)glycol ethers. In a further embodiment, the C₄-C₃₀ aliphatic acid ester may be a laurate, a myristate, a palmitate, a stearate, an oleates, a sebacate, (poly)(alkylene glycol) mono- or diacetates, (poly)(alkylene glycol) mono- or di-myristates, (poly)(alkylene glycol) mono- or di-laurates, (poly)(alkylene glycol) mono- or di-oleates, glyceryl tri(acetate), glyceryl tri-ester of C₂₋₄₀ aliphatic carboxylic acids, and mixtures thereof. In a further embodiment, the C₄-C₃₀ aliphatic ester is isopropyl myristate, di-n-butyl sebacate, and/or pentyl valerate.

In addition to the solid catalyst component and one or more activity-limiting agents as described above, the catalyst system of the present disclosure can also include a cocatalyst. The cocatalyst may include hydrides, alkyls, or aryls of aluminum, lithium, zinc, tin, cadmium, beryllium, magnesium, and combinations thereof. In an embodiment, the cocatalyst is a hydrocarbyl aluminum cocatalyst represented by the formula R₃Al wherein each R is an alkyl, cycloalkyl, aryl, or hydride radical; at least one R is a hydrocarbyl radical; two or three R radicals can be joined in a cyclic radical forming a heterocyclic structure; each R can be the same or different; and each R, which is a hydrocarbyl radical, has 1 to 20 carbon atoms, and preferably 1 to 10 carbon atoms. In a further embodiment, each alkyl radical can be straight or branched chain and such hydrocarbyl radical can be a mixed radical, i.e., the radical can contain alkyl, aryl, and/or cycloalkyl groups. Nonlimiting examples of suitable radicals are: methyl, ethyl, n-propyl, isopropyl, n-butyl, isobutyl, tert-butyl, n-pentyl, neopentyl, n-hexyl, 2-methylpentyl, n-heptyl, n-octyl, isooctyl, 2-ethylhexyl, 5,5-dimethylhexyl, n-nonyl, n-decyl, isodecyl, n-undecyl, n-dodecyl.

Nonlimiting examples of suitable hydrocarbyl aluminum compounds are as follows: triisobutylaluminum, tri-n-hexylaluminum, diisobutylaluminum hydride, di-n-hexylaluminum hydride, isobutylaluminum dihydride, n-hexylaluminum dihydride, diisobutylhexylaluminum, isobutyldihexylaluminum, trimethylaluminum, triethylaluminum, tri-n-propylaluminum, triisopropylaluminum, tri-n-butylaluminum, tri-n-octylaluminum, tri-n-decylaluminum, tri-n-dodecylaluminum. In an embodiment, the cocatalyst is selected from triethylaluminum, triisobutylaluminum, tri-n-hexylaluminum, diisobutylaluminum hydride, and di-n-hexylaluminum hydride.

In an embodiment, the cocatalyst is triethylaluminum. The molar ratio of aluminum to titanium is from about 5:1 to about 500:1, or from about 10:1 to about 200:1, or from about 15:1 to about 150:1, or from about 20:1 to about 100:1. In another embodiment, the molar ratio of aluminum to titanium is about 45:1.

The catalyst system of the present disclosure as described above can be used for producing olefin-based polymers. The process includes contacting an olefin with the catalyst system under polymerization conditions.

One or more olefin monomers can be introduced into a polymerization reactor to react with the catalyst system and to form a polymer, such as a fluidized bed of polymer particles. The olefin monomer for instance, can be propylene. Any suitable reactor may be used including a fluidized bed reactor, a stirred gas reactor, a bulk phase reactor, a slurry reactor or mixtures thereof. Suitable commercial reactors include the UNIPOL reactor, the SPHERIPOL reactor, and the like.

As used herein, “polymerization conditions” are temperature and pressure parameters within a polymerization reactor suitable for promoting polymerization between the catalyst composition and an olefin to form the desired polymer. The polymerization process may be a gas phase, a slurry, or a bulk polymerization process, operating in one, or more than one reactor.

In one embodiment, polymerization occurs by way of gas phase polymerization. As used herein, “gas phase polymerization” is the passage of an ascending fluidizing medium, the fluidizing medium containing one or more monomers, in the presence of a catalyst through a fluidized bed of polymer particles maintained in a fluidized state by the fluidizing medium. “Fluidization,” “fluidized,” or “fluidizing” is a gas-solid contacting process in which a bed of finely divided polymer particles is lifted and agitated by a rising stream of gas. Fluidization occurs in a bed of particulates when an upward flow of fluid through the interstices of the bed of particles attains a pressure differential and frictional resistance increment exceeding particulate weight. Thus, a “fluidized bed” is a plurality of polymer particles suspended in a fluidized state by a stream of a fluidizing medium. A “fluidizing medium” is one or more olefin gases, optionally a carrier gas (such as H₂ or N₂), and optionally a liquid (such as a hydrocarbon) which ascends through the gas-phase reactor.

A typical gas-phase polymerization reactor (or gas phase reactor) includes a vessel (i.e., the reactor), the fluidized bed, a distribution plate, inlet and outlet piping, a compressor, a cycle gas cooler or heat exchanger, and a product discharge system. The vessel includes a reaction zone and a velocity reduction zone, each of which is located above the distribution plate. The bed is located in the reaction zone. In an embodiment, the fluidizing medium includes propylene gas and at least one other gas such as an olefin and/or a carrier gas such as hydrogen or nitrogen.

In one embodiment, the contacting occurs by way of feeding the catalyst composition into a polymerization reactor and introducing the olefin into the polymerization reactor. In an embodiment, the cocatalyst can be mixed with the catalyst composition (pre-mix) prior to the introduction of the catalyst composition into the polymerization reactor. In another embodiment, the cocatalyst is added to the polymerization reactor independently of the catalyst composition. The independent introduction of the cocatalyst into the polymerization reactor can occur simultaneously, or substantially simultaneously, with the catalyst composition feed.

In one embodiment, the polymerization process may include a pre-activation step. Pre-activation includes contacting the catalyst composition with the co-catalyst and the activity-limiting agent. The resulting preactivated catalyst stream is subsequently introduced into the polymerization reaction zone and contacted with the olefin monomer to be polymerized.

The present invention, thus generally described, will be understood more readily by reference to the following examples, which are provided by way of illustration and are not intended to be limiting of the present invention.

### EXAMPLES

Various different xylene soluble content polypropylene homopolymers were made in accordance with the present disclosure. Four different samples of polypropylene polymers were produced and tested. All of the samples were produced using CONSISTA® C702 catalyst that is commercially available from the W.R. Grace and Company. The C702 catalyst includes a solid catalyst component containing an epoxy compound and an organosilicon compound. The C702 catalyst includes a non-phthalate compound as an internal electron donor.

For each example, the external electron donor(s) used were as follows:

### Example 1

Isopropyl myristate (IPM);

### Example 2

Pentyl Valerate (PV);

### Example 3

Isopropyl myristate and pentyl valerate in a 98% by weight to 2% by weight ratio; and

### Example 4

Isopropyl myristate and n-propyltrimethoxysilane (NPTMS).

As shown above, Example 4 included an activity-limiting agent in combination with a silicon-containing external electron donor, also referred to as a silicon-based selectivity control agent or external electron donor. Examples 1-3, on the other hand, were made in accordance with the present disclosure and only contained activity-limiting agents as external electron donors.

For Examples 1, 2 and 3, the cocatalyst to external electron donor molar ratio was about 4. For Example 4, on the other hand, the cocatalyst to external electron donor ratio was about 6.

The reactor conducted polymerization in a gas-phase fluidized bed with a compressor and cooler connected to a cycle gas line.

Polypropylene resin powder was produced in the fluidized bed reactor using the above catalysts in combination with triethylaluminum as a cocatalyst.

The fluidized bed reactor was operated under the following conditions:
Reactor Temperature: 72° C.
Propylene Partial Pressure: 320 psi
Bed weight: 68 to 72 lbs
Superficial gas velocity: 1.0 to 1.6 ft/sec

The polypropylene polymers formed from each sample set had a melt flow rate of about 3 g/min. The polypropylene homopolymers also had a xylene soluble content of about by weight.

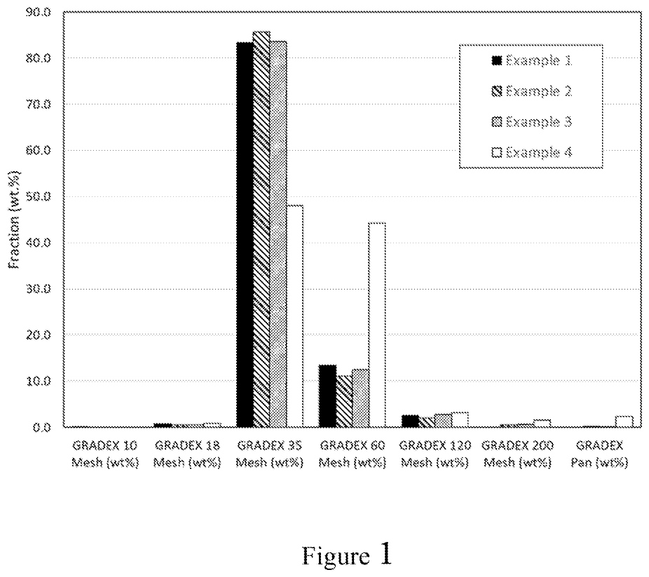

Table 1 and FIG. 1 provide the results.

TABLE 1

| Example | 1 | 2 | 3 | 4 |
|---|---|---|---|---|
| External Donor | 100% IPM | 100% PV | 98% IPM/ | 98% IPM/ |
| | | | 2% PV | 2% NPTMS |
| TEAl/Ti Molar Ratio | 50 | 50 | 50 | 50 |
| TEAL/Donor Molar | 3.9 | 12.5 | 4.2 | 6.4 |
| Ratio | | | | |
| Melt Flow Rate | 3.0 | 3.3 | 3.0 | 2.9 |
| (g/10 min) | | | | |
| Xylene Solubles | 5.1 | 5.5 | 5.4 | 5.4 |
| (wet) | | | | |
| GRADEX 10 Mesh | 0.1 | 0.0 | 0.0 | 0.0 |
| (wt %) | | | | |
| GRADEX 18 Mesh | 0.7 | 0.5 | 0.5 | 0.8 |
| (wt %) | | | | |
| GRADEX 35 Mesh | 83.3 | 85.7 | 83.6 | 48.0 |
| (wt %) | | | | |
| GRADEX 60 Mesh | 13.4 | 11.1 | 12.4 | 44.3 |
| (wt %) | | | | |
| GRADEX 120 Mesh | 2.5 | 2.0 | 2.7 | 3.2 |
| (wt %) | | | | |
| GRADEX 200 Mesh | 0.0 | 0.5 | 0.6 | 1.5 |
| (wt %) | | | | |
| GRADEX | 0.0 | 0.2 | 0.1 | 2.3 |
| Pan (wt %) | | | | |

The particle size of each sample produced was measured using a GRADE X particle size analyzer. Particle size information is provided in the FIGURE. Polypropylene polymers made according to the present disclosure had dramatically lower level of fines. As shown in the FIGURE, the polymers made according to the present disclosure had a much narrower particle size distribution. The Example 4 particles on the other hand, appeared to break apart into two primary sizes. The date demonstrates the ability to control xylene soluble content while producing a product with a more desired particle size distribution.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A polymer composition comprising:
a polypropylene polymer comprising a polypropylene homopolymer or a polypropylene copolymer containing a comonomer in an amount less than about 1% by weight;
wherein:
the polypropylene polymer exhibits a xylene solubles content of greater than about 4.0% by weight;
the polypropylene polymer exhibits a melt flow rate of from about 0.5 g/10 min to about 20 g/10 min; and
the polypropylene polymer contains silicon in an amount less than about 10 ppm or is free of silicon.

2. The polymer composition of claim 1, wherein the polypropylene polymer exhibits a xylene solubles content of greater than about 5.0% by weight, such as greater than about 6% by weight, such as greater than about 6.2% by weight, such as greater than about 6.4% by weight, and generally less than about 8.5% by weight.

3. The polymer composition of claim 1, wherein the polypropylene polymer is a polypropylene homopolymer.

4. The polymer composition of claim 1, wherein the propylene polymer is in the form of polymer particles, and, wherein, when tested according to a Sieve Test, the polymer particles have a particle size distribution such that greater than about 55% by weight of the particles, such as greater than about 70% by weight of the particles, such as greater than about 75% by weight of the particles, such as greater than about 80% by weight of the particles falls between a 1000 micron Sieve and a 500 micron Sieve.

5. The polymer composition of claim 4, wherein less than 1% by weight, such as less than about 0.75% by weight, such as less than about 0.5% by weight of the polymer particles can pass through a 125 micron Sieve.

6. The polymer composition of claim 4, wherein less than about 20% by weight of the polymer particles, such as less than about 15% by weight of the particles fall between a 500 micron Sieve and a 225 micron Sieve.

7. The polymer composition of claim 1, wherein the polypropylene polymer is prepared in the presence of a Ziegler-Natta catalyst comprising an internal electron donor, wherein the internal electron donor comprises a substituted phenylene diester.

8. A polymer film comprising:
a biaxially oriented polymer layer having a thickness of less than about 50 microns, the polymer layer comprising a polymer composition containing a polypropylene polymer,
the polypropylene polymer comprising a polypropylene homopolymer or a polypropylene copolymer containing a comonomer in an amount less than about 1% by weight, the polypropylene polymer exhibiting a xylene solubles content of greater than about 4.5% by weight, the polypropylene polymer exhibits a melt flow rate of from about 0.5 g/10 min to about 20 g/10 min, the polypropylene polymer containing silicon in an amount less than about 10 ppm or being free of silicon.

9. The polymer film of claim 8, wherein the polypropylene polymer exhibits a xylene soluble content of greater than about 5.0% by weight, such as greater than about 6% by weight, such as greater than about 6.2% by weight, such as greater than about 6.4% by weight, and generally less than about 8.5% by weight.

10. The polymer film of claim 8, wherein the polypropylene polymer is a polypropylene homopolymer.

11. The polymer film of claim 8, wherein the polypropylene polymer is catalyzed in the presence of a Ziegler-Natta catalyst comprising an internal electron donor, the internal electron donor comprising a substituted phenylene diester.

12. The polymer film of claim 8, wherein the polymer film is a multi-layer film, the biaxially oriented polymer layer comprising at least one layer within the polymer film.

13. The polymer film of claim 8, wherein the polypropylene polymer has a molecular weight distribution of greater than about 2.5.

14. A packaging film comprising the polymer film of claim 8.

15. A process for producing a polypropylene polymer comprising:
polymerizing a propylene monomer in the presence of a Ziegler-Natta catalyst, the Ziegler-Natta catalyst including a catalyst component and an activity-limiting agent, the solid catalyst component comprising a magnesium moiety, a titanium moiety, and an internal electron donor, the propylene monomer being polymerized in the absence of any silicon-containing external electron donors; and
forming a polypropylene polymer exhibits a xylene soluble content of greater than about 4.0% by weight and exhibits a melt flow rate of from about 0.5 g/10 min to about 20 g/10 min.

16. The process of claim 15, wherein the propylene monomer is polymerized in the presence of the solid catalyst component and the activity-limiting agent without the use of any silicon-based external electron donors.

17. The process of claim 15, wherein the polypropylene polymer exhibits a xylene solubles content of greater than about 5.0% by weight, such as greater than about 6% by weight, such as greater than about 6.2% by weight, such as greater than about 6.4% by weight, and generally less than about 8.5% by weight.

18. The process of claim 15, wherein the internal electron donor comprises a substituted phenylene diester.

19. The process of claim 15, wherein the activity-limiting agent comprises isopropyl myristate, pentyl valerate, or a mixture of any two or more thereof.

20. The process of claim 15, wherein the catalyst used to form the polymer has a cocatalyst to activity-limiting agent molar ratio of less than 5, such as less than 4.5, and generally greater than about 2.5.
